(19) United States
(12) Patent Application Publication
(10) Pub. No.: US 2006/0012455 A1
(43) Pub. Date: Jan. 19, 2006

(54) Litz wire fixation for low building height

(75) Inventors: Jan Henricus Maria Hopmans, Eindhoven (NL); Cornelis Henricus Petrus Van Limpt, Eindhoven (NL); Adviomus Antonius Roche, Eindhoven (NL); Nicolaas Josephus Schepens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/531,028

(22) PCT Filed: Sep. 12, 2003
(86) PCT No.: PCT/IB03/03950

§ 371 Date: Apr. 12, 2005

(30) Foreign Application Priority Data
Oct. 16, 2002 (EP) 02079281.8

(51) Int. Cl. H01F 27/08

(52) U.S. Cl. 336/55

(57) ABSTRACT

The invention relates to a coil (1) comprising at least one pin with an end for anchoring a woven wire, preferably a litz wire resulting in a low building height. Said pin end has a U-shaped part (3) forming a slot (5), said slot (5) has an inner width equal to or smaller than the diameter of the wire (4). It is thereby obtained that the anchoring pin provides a secure anchoring position for the wire during wrapping and that the anchoring pin can be used for litz wire, thereby overcoming the drawbacks in the prior art as well as obtaining a good foundation for the subsequent soldering process. Furthermore it is obtained that height of the coil is smaller than the prior-art coils.

This invention relates to a coil comprising at least one pin with an end for anchoring a woven wire, preferably a litz wire resulting in a low building height.

The wires used for manufacturing a coil are of various types and shapes. This invention relates primarily to a litz wire, which is a wire woven of several strands. The individual strands may be bunched or braided together in a uniform pattern of twists and length of lay.

The litz wire, also called “litzendraht” wire, is thereby a bundle of individually insulated strands, and may for instance be 16 strands of 0.1 mm (16*0.1) in diameter. The isolation material may for example be a polymer. Some litz wires are further isolated by for instance textile.

Litz wire is used in coils to minimize the power loss and to reduce the so-called “skin-effect” at high frequencies, which is often encountered in a solid conductor. A bundle of individual strands has a lower AC resistance than one solid strand/conductor having the same cross section area. The AC resistance can be translated as a resistance which expresses the total losses in a component, namely the DC resistance, skin-effect, proximity effect and core losses.

Furthermore, to achieve the best result of the litz wire it is essential to position each individual strand in the litz construction in a uniform pattern moving from the center to the outside and back at a given length.

The connector pin in coils is used to connect the wire ends, so that one end of the wire is anchored before winding the wire around the coil and the other end is subsequently anchored after the winding. The anchoring of the wire is performed to maintain the wire in a certain position prior to a soldering of the wire, and the anchoring in the prior art is performed by wrapping the wire around the pin several times.

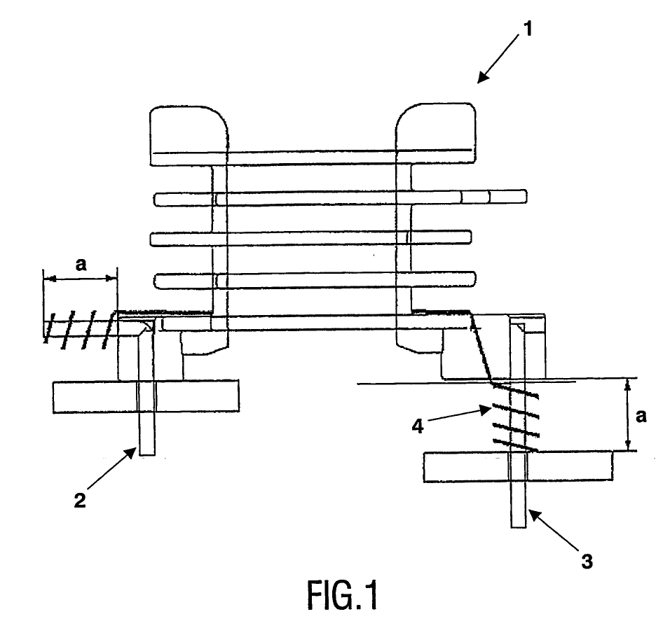

In the known coils 1 the connector pins are typically L-shaped 2 or I-shaped 3 as shown in FIG. 1. In order to establish a secure positioning of the wire around the prior-art pins, the wire is wrapped essentially two to four times around the pin as shown in FIG. 1. Accordingly, the extent of that part of the pin, shown by reference “a” in FIG. 1, is typically at least two to four times the diameter of the wire, which results in a coil with an extensive width.

Furthermore, when litz wire is wrapped around the prior art pins, the litz wire has the tendency to release itself from the pin due to the fact that the individual strands straighten themselves, thereby creating a distance between the wire and the pin. Hereby is achieved that the solder at the soldering process slips through and thereby the soldering does not have the effect it was supposed to have.

The release of the litz wire is, however, not directly a disadvantage for the soldering due to the capillary action of the tin solder. But too loose wires may shift or unwrap during the time between winding and soldering, which in this instance can result in bad soldering or even short circuit.

In EP 0 304 593 a coil is disclosed, wherein a wire is held near the connector pin, whereupon the pin is bent to squeeze around the wire and thereby maintain the wire in this position before the soldering process. This squeezing process is not sufficient to hold a litz wire before the winding process of the coil due to the forces used in the winding process, and therefore these pins are not useful for litz wires.

Nor are the known connector pins in coils particularly usable for litz wires since it is not possible to maintain the litz wires in position before and during soldering only by wrapping the litz wire around an anchoring pin several times as explained above.

Furthermore, to achieve the best soldering result, all the strands inside the litz wire must be soldered and therefore exposed to the soldering process, which is not properly done only by wrapping the litz wire around the pin due to the fact that a litz wire releases itself from the pin because the strands find their way back to their initial position where they are straightened the most.

An object of the present invention is to provide a coil wherein contact between the wire and the anchoring pin is obtained and wherein the individual strands are more or less exposed to the soldering process during the anchoring of the wire.

Another object of the present invention is to provide a coil which is suitable for litz wire and which spreads the individual strands during the anchoring of the wire before the soldering of the wire.

A further object of the present invention is to minimize the height and the width of the coil.

The above objects are obtained according to the present invention by the pin end having a U-shaped part forming a slot, said slot having an inner width equal to or smaller than the diameter of the wire.

As the inner width of the slot is equal to or smaller than the diameter of the wire, the wire is firmly secured in the slot, and further fixation of the wire can be obtained by wrapping the wire one time around the anchoring pin and then once again securing it in the slot. The further anchoring of the wire is especially used in the anchoring of the wire before the winding process of the coil.

By the inventive coil it is obtained that the anchoring pin provides a secure anchoring position for the wire during wrapping and that the anchoring pin can be used for litz wire, thereby overcoming the prior-art drawbacks described above as well as obtaining a good foundation for the subsequent soldering process.

The coil according to the present invention furthermore provides an anchoring pin which makes the mounted coil smaller in height without making the coil bigger in width in relation to the prior-art coils.

By using the coil according to the present invention the anchoring of the wire is carried out by pulling the wire into the slot of the anchoring pin of the coil. Prior to the winding process of the coil it can be advantageous to wrap the wire one time around the anchoring pin and then pull into the slot once more. It is hereby obtained that the litz wire is securely held by the anchoring pin without the litz wire releasing itself from the pin due to its springiness as explained above.

Furthermore it is obtained that the litz wire is deformed so that most of the individual strands in the wire are exposed to the soldering process. It is hereby obtained that the capillary-effect can be used during the soldering process due to the small distance between the wire and the pin and the small mutual distance between the strands, which surprises the skilled person.

In advantageous embodiments according to the present invention the pin end of the anchoring pin projects horizontally or vertically in a radial direction from the coil. Hereby is obtained that the height of the coil is minimized without jeopardizing the secure positioning of the wire.

In advantageous embodiments according to the present invention the width of the slot decreases towards the closed end of the slot. This decreasing width makes the anchoring of wires with various diameters possible.

The term anchoring pin is in the context of this specification to be construed as any kind of bendable rigid metal or metal covered with a solderable plating in the form of a pin as well as a rod, bar, pole, stick, pipe, tube, shaft or stump.

The term anchor is in the context of this specification to be construed as a fixing of a movable object, here the wire, to a fixed object, here the anchoring pin, so that the movable object is not only maintained but also held in the firmly secured position.

The above, as well as additional advantages of the present invention, will be better understood through the following illustrative and non-limiting detailed description of preferred embodiments of the present invention, with reference to the appended drawings, wherein:

FIG. 1 shows a coil with a known L-shaped connector pin and a known I-shaped connector pin. It is for illustration purpose only that the coil includes both an I-shaped and an L-shaped connector pin.

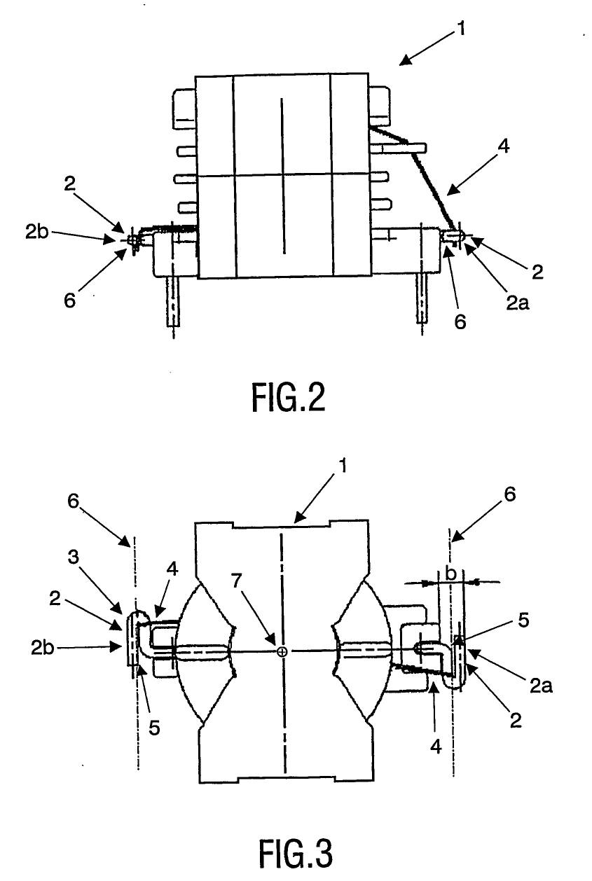

FIG. 2 shows a coil seen from the side, illustrating the placement of the anchoring pins according to the invention.

FIG. 3 shows the coil arrangement seen from above of FIG. 2.

All Figures are schematic and are not to scale, and show only parts necessary for the clarification of the preferred embodiments of the present invention.

FIG. 2 shows a coil 1 according to a first embodiment of the present invention comprising two anchoring pins 2a, 2b and a wire 4 which before the winding of the wire 4 around the coil 1 is anchored in the first pin 2b and likewise wire 4 is anchored in the second pin 2a after the winding process.

FIG. 3 shows a coil 1 seen from above of FIG. 2 according to a first embodiment of the present invention, where the coil 1 comprises the pin 2 with the end for anchoring the woven wire 4, preferably a litz wire, where said pin 2 end has a U-shaped part 3 forming a slot 5, and said slot 5 has an inner width equal to or smaller than the diameter of the wire 4, where the slot 5 may in expedient manner anchor the wire 4 before and during the soldering of the wire 4.

Hereby is obtained that the wire 4 is anchored in the slot 5 by the friction between the surface of the wire 4 and the inner side of the slot 5 due to the deformation of the wire 4 pulled into the slot 5. The individual strands of the litz wire 4 are spread more or less from each other during the anchoring of the wire 4 in the slot 5, and thereby the pin 2 is having contact with substantially most of the wire 4 and the individual strands, which creates a good basis for a perfect soldering of the wire 4 and the individual strands.

In FIGS. 2 and 3 the anchoring pin 2 is shown as having a U-shaped part 3 projecting in a radial direction from the coil 1. And as shown in FIG. 3 the U-shaped part 3 of the anchoring pin 2 is substantially in the horizontal plane of the coil 1, and the center axis of the slot 5 is in a 90° angle to the central axis of the coil 1.

In another embodiment according to the present invention the width of the slot decreases towards the closed end of the slot 5 so as to form a more open U-shape (not shown).

Furthermore the U-shaped part 3 of the anchoring pin 2 may be straighter in the bottom of the slot 5 so as to form a more square-shaped U-slot (not shown).

In further embodiments of the present invention the shape of the slot 5 is a V-shape so as to accommodate wires of different diameters. It is possible in this respect to vary the design or shape of the slot to the individual wire being used without departing from the inventive idea. Common for shapes of the slots are that they have equal or smaller width than the diameter of the wire pulled through it.

In expedient manner according to the present invention the U-shaped part 3 of the anchoring pin 2 may project vertically in a radial direction from the coil 1, so that the slot 5 is parallel with the central axis of the coil 1.

In further preferred embodiments of the present invention the U-shaped part 3 of the anchoring pin 2 may project in a radial direction from the coil 1, so that the central axis 6 of the slot 5 is at a random angle to the central axis 7 of the coil 1. Hereby this choice of angle between the central axis 6 of the slot 5 and the central axis 7 of the coil 1 is appreciated by the skilled person during the optimization of the production of the coil in finding the best and most efficient manufacturing of the coil.

According to the invention litz wires may for instance have the following dimensions (number of individual strands*diameter) 16*0.1 mm, 20*0.1 mm, 20*0.71 mm, 25*0.071 mm, 80*0.071 mm and 4*0.2 mm and be used in connection with a slot having an inner width of 0.25 mm and litz wires having for instance the dimension of 80*0.1 mm may be used in connection with a slot having an inner width of 0.8 mm. These examples have shown to be advantageous due to the smaller width of the slot compared to the diameter of the wire and thereby obtaining a secure positioning of the wire.

The use of the above mentioned litz wires in connection with the respective slots has shown that the wires are deformed in some degree as the wire is pulled into the slot and the individual strands of the wire 4 are furthermore spread somewhat at the anchoring of the wire 4 in the slot 5. This provides that the solder is sucked in between the strands of the wire by means of the capillary-effect due to the small distance between the pin 2 and the wire 4 and the small mutual distance between the strands.

In practice the distance a in FIG. 1 has shown to be larger than the distance b in FIG. 3, which makes the anchoring pin of the present invention advantageous because it makes the coil width smaller without making the coil higher compared to the known L-shaped and I-shaped anchoring pins

Further, the coil according to the invention may advantageously be used for power conversion applications, such as UHP ignition transformer for beamers or LCD projection television.

Furthermore, the coil according to the invention may be used for SMD (Surface Mounted Devices) mounting.

Although the present invention is disclosed by the preferred embodiments of the present invention, it is obvious to any person skilled the art that several improvements are possible without deviating from the present invention as defined in the following claims.

1. A coil (1) comprising at least one pin (2) with an end for anchoring a woven wire (4) preferably a litz wire, characterized in that said pin end has a U-shaped part (3) forming a slot (5), said slot (5) has an inner width equal to or smaller than the diameter of the wire (4).

2. A coil (1) according to claim 1, characterized in that said pin end projects horizontally in a radial direction from the coil (1).

3. A coil (1) according to claim 1, characterized in that said pin end projects vertically in a radial direction from the coil (1).

4. A coil (1) according to claim 1, characterized in that said width of the slot (5) decreases towards the closed end of the slot (5).

5. An anchoring pin for a coil, said pin comprising an end having a U-shaped part (3) forming a slot (5), and said slot (5) having an inner width equal to or smaller than the diameter of a litz wire (4).

6. A power converter provided with a coil as claimed in claim 1.

7. A power converter having a coil provided with an anchoring pin as claimed in claim 5.
